(19) United States
(12) Patent Application Publication
(10) Pub. No.: US 2005/0039403 A1
(43) Pub. Date: Feb. 24, 2005

(54) Sash window tilt stay

(76) Inventor: Simon Christopher Braid, Peterborough (GB)

Correspondence Address: RICHARD M. GOLDBERG, 25 EAST SALEM SREEET, SUITE 419, HACKENSACK, NJ, 07601, US

(21) Appl. No.: 10/920,745

(22) Filed: Aug. 18, 2004

(30) Foreign Application Priority Data
Aug. 20, 2003 (GB) 0319562.5

(51) Int. Cl. E05D 15/22

(52) U.S. Cl. 49/187

(57) ABSTRACT

A sash window tilt stay assembly (30) for a tiltable sash window (1) includes a window jamb attachment (36), and a sash attachment (34). The window jamb attachment (36) is adapted to be slidably engaged within a window jamb channel (22,24) of the sash window (1), and is pivotally attached to a first end of the stay (30) by a rivet (38). The sash attachment (34) is adapted to attach to the window sash (2,4). The sash attachment (34) includes an elongate slot (52) and the stay includes a cooperating spigot (54) which projects from the stay (30) to attach the sash attachment (34) to a second end of the stay (30). The spigot (54) is slidably and rotatably retained within the elongate slot (52) by an enlarged head portion (58) of the spigot (54).

The present invention relates to sliding sash windows. In particular it relates to a sash windows in which the window sashes can be tilted from a vertical position for cleaning, replacement or repair. More specifically the invention relates to a stay arrangement for such sash windows in order to support the window sashes in a tilted position.

For cleaning of a sash window, repair, maintenance or installation/removal, it is common for the sash window sashes to be arranged so that they can be tilted from an installed vertical plane. Typically the window sashes are pivoted about lower pin mountings with an upper mounting pin being retracted or otherwise disengaged from the window jamb channel to allow the window to be so tilted.

In order to prevent the tilted window sashes from falling and pivoting completely out of the window frame, and to support the window sashes in a tilted position, a tilt stay (or preferably a pair of tilt stays) may be provided between the window sashes and frame. One end of the tilt stay is connected to a side of the window sashes part way along their sides, whilst an opposite end of the tilt stay is connected to the window jamb. The tilt stay, when the window sashes are tilted accordingly forms a brace supporting the window sashes in a tilted position. When the sash window is in a vertical, normal, position the tile stay lies in line with and along the side of the sash window and window channel jamb. When the window sashes are vertical the tilt stay must then allow the window sashes to be vertically slid in the window frame.

It is important that the tilt stay is adequately secured to both the side of the window sashes and to the window channel jamb. It is also important to ensure that the tilt stay, when the window sashes are in the normal vertical position, does not impeded the sliding of the window sashes within the window frame. Similarly the tilt stay whilst supporting a tilted window sashes must also not impeded tilting of the window sashes to a tilted position. Coupled to these operating requirements the tilt stay must also be easy and quick to correctly install and assemble within the window in a production environment and must be inexpensive.

It is therefore desirable to provide an improved sash window arrangement, and in particular a tilt stay arrangement for a sash window, which addresses the above considerations and/or which offers improvements generally.

According to the present invention there is provided a sash window tilt stay assembly, and a sash window including such a tilt stay, as described in the accompanying claims.

In an embodiment of the invention there is provided a sash window tilt stay assembly for a tiltable sash window and for attachment between a window sash and a window jamb of a sash window. The tilt stay assembly comprising an elongate stay member, a window jamb attachment, and a sash attachment. The window jamb attachment is pivotally attached to a first end of the stay member by a rivet and the window jamb attachment is adapted to be slidably engaged within a window jamb channel of the sash window. The sash attachment is adapted to be attached and secured to the window sash. The sash attachment includes an elongate slot and the stay member includes a cooperating spigot which projects from the stay member to attach the sash attachment to a second end of the stay member. The spigot comprises a neck portion and an enlarged distal head portion with the neck portion being slidably and rotatably retained within the elongate slot by the enlarged head portion.

Such an assembly, with the sash attachment and window jamb attachment mounted upon and integral with the stay member as a single unit, is simple, quick and easy to install within a sash window and to the window jamb and sashes. At the same time the tilt stay assembly provides the required secure location, and by virtue of the slidable mounting provided by the slot of the sash attachment, has a reduced tendency for the stay to jam in use. The tilt stay can also be supplied as a single assembly for fixing into a sash window with few if any further separate components being required. This reduces inventory holdings and the possibility of required separate parts being lost.

Preferably the window jamb attachment comprises a central portion and first and second side flanges which oppositely laterally project from the central portion. The window jamb channel includes a pair of front walls which partially close off the window jamb channel. The side flanges are arranged to be slidably engaged within and behind the front walls. Furthermore the first side flange may project further from the central portion than the second flange. A distal edge of the second side flange may have a curved profile.

The window jamb attachment is preferably adapted to be fitted into the window jamb channel by inserting the first side flange into the window jamb channel at an angle and subsequently pivoting the window jamb attachment about the first flange to force the second flange over and behind the respective front wall of the window jamb channel.

The sash attachment is attached and secured to the window sash by at least one screw fastener. Preferably however the sash attachment is attached and secured to the window sash by a snap-fit fastener which projects from one of the sash attachment or window sash and is engaged within a corresponding aperture in the other of the sash attachment or window sash. The snap-fit fastener may comprise at least one resilient projection with a distal end of the projection comprising an enlarged snap head. The resilient projection is arranged to deflect as and to allow the projection and enlarged snap head to be inserted into and through the aperture with the enlarged snap head then retaining the projection and fastener within the aperture. The snap-fit fastener comprises a plurality of projections which together cooperatively define a composite cylindrical snap-fit fastener assembly with a circular enlarged snap head wherein each of the projections comprises a segment of the composite cylindrical snap-fit fastener assembly. The enlarged snap head may have a tapered profile.

The present invention will now be described by way of example only with reference to the following figures in which:

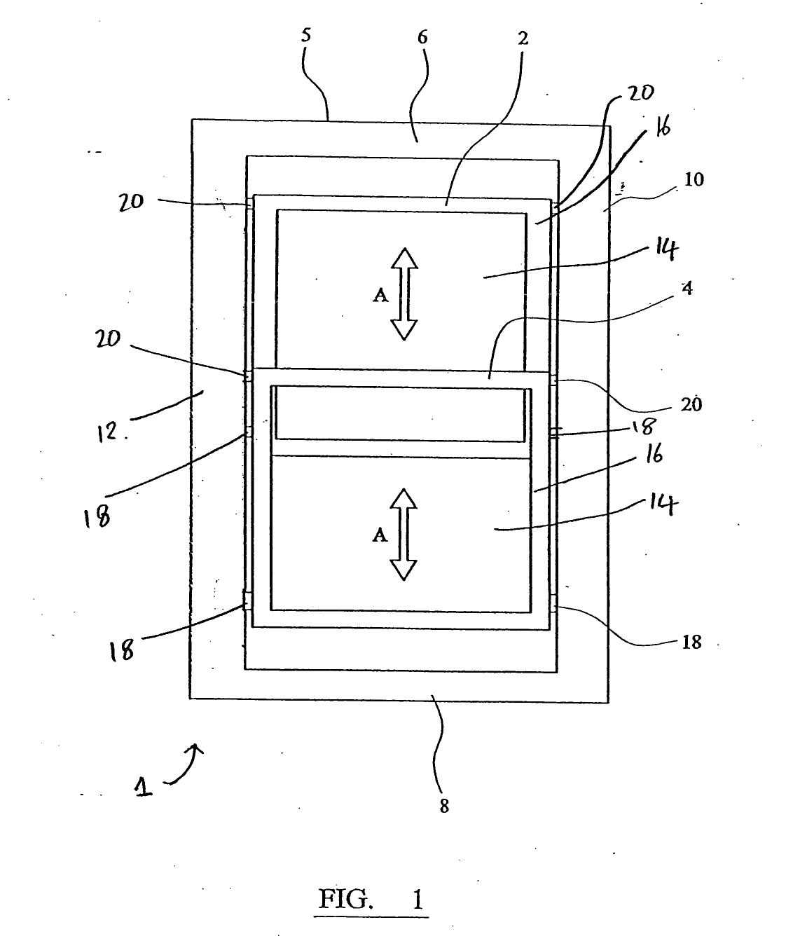

FIG. 1 schematic illustration of a sash window assembly including a pair of window sashes installed within a window frame;

FIG. 2 is a perspective illustrative more detailed view of the sash window of FIG. 1 with part of the window jamb channel cutaway, and showing the lower window sash in a tilted position, and showing the tilt stay assembly of an embodiment of the present invention;

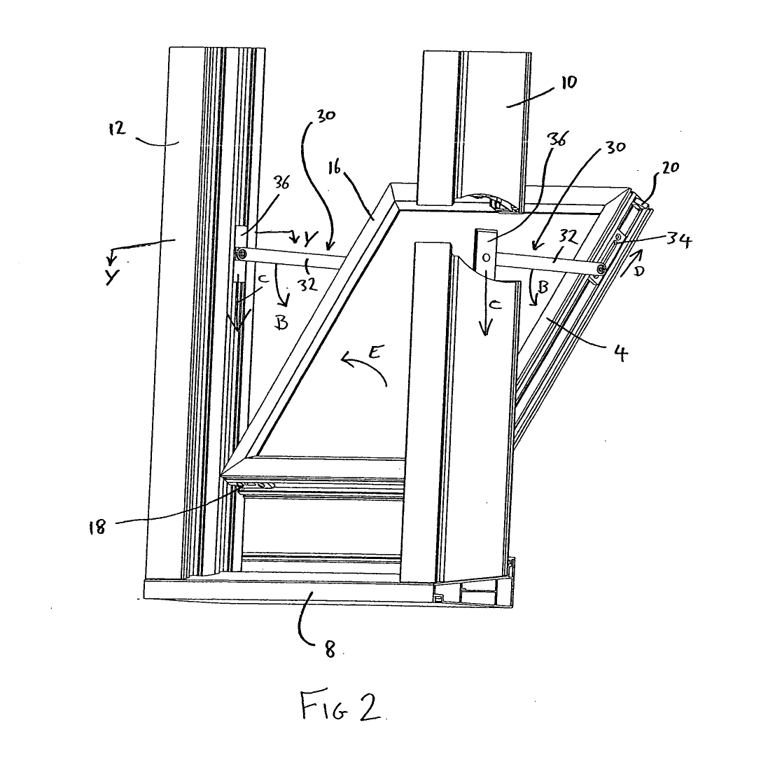

FIG. 3 is a perspective illustrative view of the tilt stay assembly shown in FIG. 2;

FIG. 4 is a cross sectional view along line X-X of FIG. 3 through the window sash attachment end of the tilt stay;

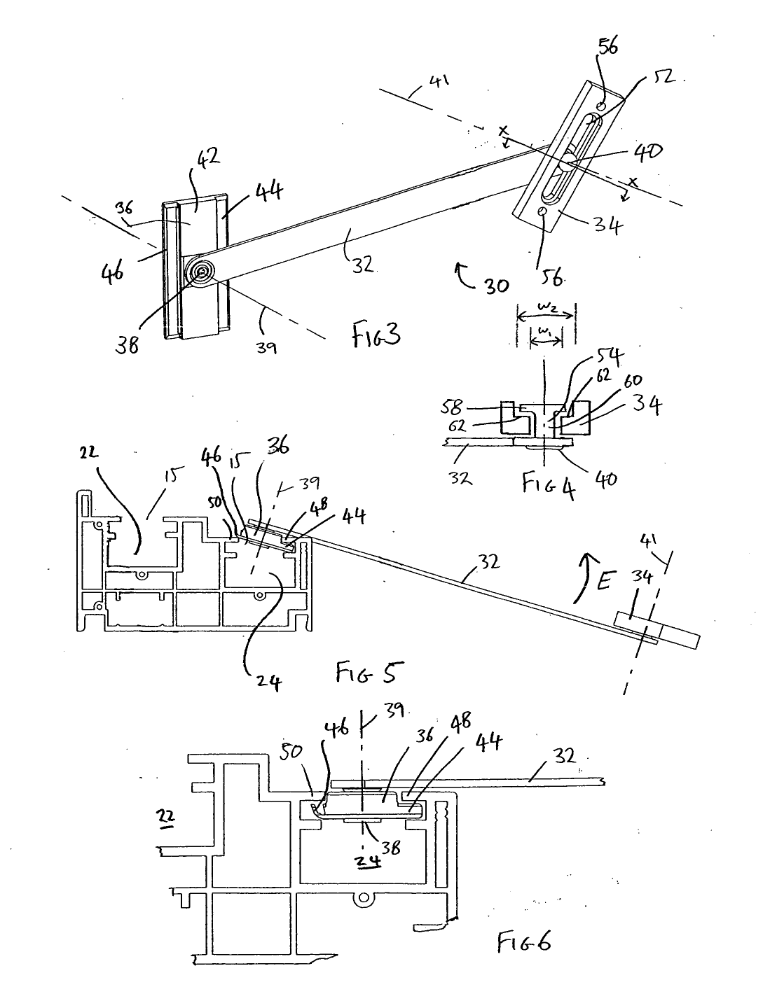

FIG. 5 is a cross sectional view along line Y-Y through the window channel jamb and illustrating the installation of the window channel jamb attachment of the tilt stay within the window channel jamb;

FIG. 6 is a more detailed view, similar to FIG. 5 but showing the window channel jamb attachment of the tilt stay fitted into the window channel jamb;

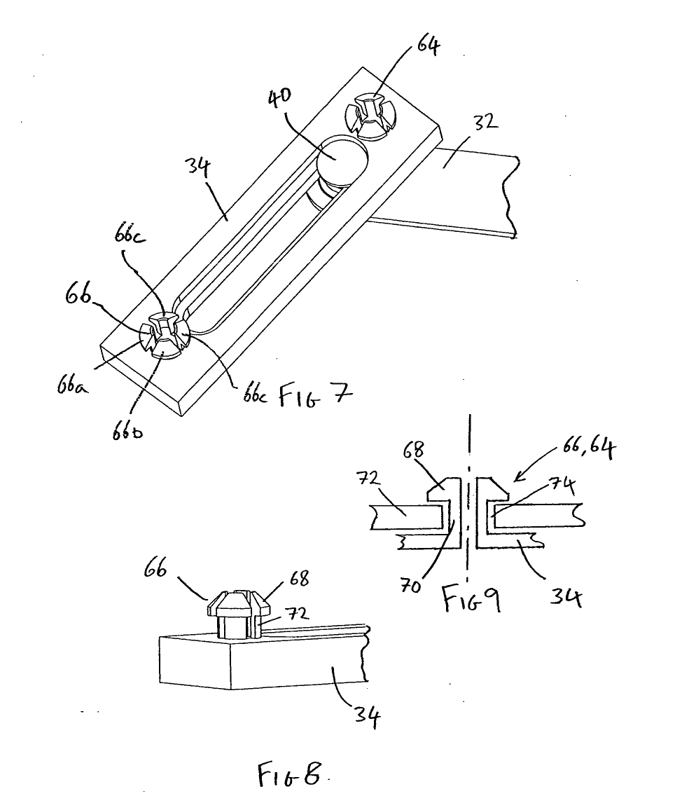

FIG. 7 is a detailed perspective view of a window sash attachment of a tilt stay according to a second embodiment of the present invention;

FIG. 8 is a more detailed illustrative perspective view of the snap-fit fastener of the window sash attachment of a tilt stay shown in FIG. 7; and

FIG. 9 is a more detailed cross sectional view through the snap-fit fastener shown in FIGS. 7 and 8 and showing the engagement of the snap-fit fastener within a mounting aperture in the wall of the window sash frame.

Referring to FIG. 1, a sash window 1 comprises upper 2 and lower 4 sashes which are slidably mounted within a window frame 5 such that each sash 2,4, can be slid vertically to open the window 1. The sashes 2,4, are disposed generally vertically in an overlapping arrangement with one disposed closely adjacent to the other and in operation sliding behind each other. Each window sash 2,4 comprises a peripheral frame 16 surrounding and enclosing a glass window pane 14.

The window frame 5 comprises a top header 6 and a bottom sill 8 as horizontal frame members and two vertical laterally spaced window jamb members 10,12. The window jamb members 10,12, each define and include a pair of double vertically extending window jamb channels 22,24 which are shown in cross section in more detail in FIGS. 5 and 6. The sash window sashes 2,4 are slidably located and engaged within respective channels 22,24 of the window jamb channel 10,12. An open part 15 of the channel sections 22,24 faces a respective lateral side of the sash window 12,14. The window frame 5, and window jamb channels 10,12 are typically fabricated from extruded uPVC sections which are joined together to form the window frame 5. Alternatively, and as is known the window frame and window jamb can be made from Aluminium, wood, or other suitable materials.

Lower mounting pivot pins 18, located towards the lower part of the window sashes 12,14, extend and project laterally from the sides of the window sashes 2,4 at the bottom end of the window sashes 2,4. The pivot pins 18 project into the window jamb channel sections 22,24. Tilt latches 20, or pins, located towards the upper part of the sash window sashes 2,4, similarly project laterally from the sides of the sash window sashes 2,4. The distal ends of the tilt latches 20 are located and project within the open part 15 of the respective window jamb channels 22,24. The sash windows sashes 2,4, are thereby slidably located within and with respect to the window frame 5 by the locating of the pivot pins 22 and tilt latches 20 within the window jamb channels 22,24. The tilt latches 20 are also laterally retractable with respect to the window sashes 2,4, such that the distal ends of the tilt latches 20 can be withdrawn from the window jamb channels 22,24. This allows the upper part of the window sashes 2,4 to be disengaged allowing the window sashes 2,4 to be tilted and pivoted about the pivot pins 22 as shown in FIG. 2.

Counterbalance arrangements (not shown), for example spring counterbalance mechanisms, to counterbalance the weight of the window sashes 2,4 and make vertical sliding of the window sashes 2,4, easier, are also typically mounted and located within the window jambs 10,12. Such counterbalance arrangements are described for example in U.S. Pat. No. 6,393,661, U.S. Pat. No. 6,412,144, GB 2369644 (which are incorporated herein by reference) amongst many others. It will also be appreciated that other spring and other counterbalance arrangements can be used.

As described above the arrangement is generally conventional.

Referring to FIG. 2, a pair of tilt stays 30 extend between the window sashes 2,4 and the window jambs 10,12 at either side of the sash window 1. The stays 30 are spaced from the lower pivot pins 18 and, as shown are located towards the upper part of the respective window sashes 2,4. A first end of the tilt stay 30 is pivotally and slidably attached and engaged in the window jamb channel 22,24. A second end of each tilt stay 30 is pivotally attached to the side of a side frame 16 of the window sash 2,4. The attachment of the tilt stay 30 to the window sashes 2,4 and window jamb 10,12 will be explained in further detail later on.

The tilt stays 30, as shown, support the window sashes 2,4 when in a tilted position when the window sashes 2,4 are titled from the vertical plane, and prevent the upper part of the window sashes 2,4 from completely falling out of the window frame 5. With the window sashes 2,4 supported in a tilted position by the tilt stays 30 the window sashes 2,4, and in particular the outside (exterior facing side) of the window sashes 2,4, can be easily cleaned inspected and other maintenance carried out.

When the window sashes 2,4 are returned to a vertical position within the window frame 5 the tilt stays 30 pivot about their mountings (as indicated by arrow B) and the window jamb end of the tilt stay 30 slides vertically in the window jamb channels 22,24 (as shown by arrow C) such that the tilt stay 30 lies longitudinally along the side of the window sash frame 16, vertically in line with the window jamb 10,12, when the window sashes 2,4 are in a vertical position within the window frame 5. As the window sashes 2,4 are then vertically slid and moved within the window frame 5 the tilt stay 30 similarly slides within the sash window 1 and along the window jamb 10,12 with the window jamb end of the tilt stay 30 sliding within the window jamb channel 22,24.

One of the pair of tilt stays 30 is shown in isolation in more detail in FIG. 3. The tilt stay assembly 30 comprises an elongate stay member 32, a sash attachment 34, and a window jamb attachment 36. The window jamb attachment attaches a first end of the tilt stay assembly 30 to the window jamb 10,12, whilst the sash attachment 34 attaches a second end of the tilt stay 30 to the window sash 2,4. The window jamb attachment 36 and stay attachment 34 are preferably permanently attached and mounted onto the stay member 32 such that they are integral with the tilt stay and the tilt stay assembly comprises a single unit. The elongate stay member 32 typically comprises a thin flat rigid metal strip, whilst the sash attachment 34 and window jamb attachment 36 typically comprise plastic mouldings.

The window jamb attachment 36 is a generally rectangular planar element configured to fit within and be installed within the window jamb channel 22,24. The window jamb attachment 36 comprises a central portion 42 and a first 44 and second 46 side edge flanges which project laterally from the central portion 42. A rivet 38 pivotally attaches the window jamb attachment 36 to a first end of the stay member 32 such that the window jamb attachment 36 can freely pivot and rotate about the rivet 38 and an axis 39 perpendicular to the window jamb attachment 36 and stay 30. The window jamb attachment 36 is slidably located and engaged within the window jamb channel 24 of the window jamb 10,12 to slidably attach the first end of the tilt stay assembly 30 to the window jamb 10,12. As shown in FIG. 6, which shows the window attachment 36 engaged and located within the window jamb channel 24, the window jamb channel 24 is partially closed off by a pair of front walls 48. The side flanges 44,46 of the window jamb attachment 36 are disposed behind the front walls 48,50 to retain the window jamb attachment within the channel 24.

The window jamb attachment 36 is preferably installed within the window jamb channel 24 by inserting the first side edge flange 44 into the channel 24 and behind the respective front wall 48 with the window jamb attachment 36 inclined at an angle, as shown in FIG. 5. In this inclined position the second side flange 46 is disposed in front of the respective front wall 50. The window jamb attachment 36 is then pivoted about the distal edge of the first side edge flange 44 into the installed position (shown in FIG. 6) with the second side flange 46 being urged and forced past and behind the front wall 50. The second side edge flange 46, and/or the front wall 50 resiliently deflect to allow the side edge flange 46 to be urged past and behind the front wall 50. The side edge flange 46 and/or front wall 50 then resiliently springing back to their normal position to retain the side edge flange 46 behind the front wall 50 once the window jamb attachment 36 is installed.

To provide additional leverage during this operation the stay member 32 may be held out at angle and away from the window jamb 10,12 and used as a lever, with the stay 30 being pivoted as shown by arrow E. In addition to allow the second side edge flange 46 to be more easily urged behind the front wall 50 the second side edge flange 46 does not project laterally as far as the first side edge flange 44 from the central portion 42, and may be shorter than the first side edge flange 44. The distal edge of the second side edge flange 46 also has a curved profile curving back on itself and towards the central portion 42. The second side edge flange 46 also has a thinner cross section rendering it more flexible and resilient. It will however be appreciated that the second side edge flange 46 need not incorporate all of these features, and may be identical to the first side edge flange 44 in particular if the front wall 50 is arranged to deflect.

The sash attachment 34 includes an elongate slot 52 defined therein. A spigot 54 projects normally from the second end stay member 32. The spigot 54 has a neck portion 60 and an enlarged head portion 58 spaced from the stay member 32 and at the distal end of the spigot 54 and neck portion 60. The spigot 54 is located within the elongate slot 52 to attach the sash attachment 34 to the stay member 32. As shown in more detail in FIG. 4 the elongate slot 52 has a stepped cross sectional profile, corresponding to the spigot 54 dimensions and profile, with a pair of ridges 62 or shoulders being defined along opposite sides the length of the slot 52. The slot 52 has a first width W₁ corresponding to the size of the neck portion 60 (or slightly larger than), and then opens out to a wider width W₂ corresponding to the size of the enlarged head 58. The spigot 54 is located within and through the slot 52 with the sash attachment 34 being retained on and attached to the spigot 54 by the engagement of the enlarged head 58 with the shoulder/ridges 62 of the slot 52. It will be appreciated that in an alternative embodiment the slot 52 may be of a constant profile and single width W₁ corresponding to the width of the neck portion 60. The sash attachment 34 is then sandwiched between the enlarged head 58 and stay member 32. Rather than the enlarged head 58 being located in a portion of the slot 52, the enlarged head 58 simply abuts against an upper surface of the sash attachment 34, and the region of the stay member 32 adjacent the spigot 54 abuts against a lower surface of the sash attachment 34.

In this manner the sash attachment 34, and so window sash 2,4, is both pivotally and to a limited degree also slidably attached to the stay 30 with the sash attachment 34 being freely rotatable about the axis 41 of the spigot 54 and the spigot 54 being slidable along the length of the slot 52. This limited slidable attachment of the sash attachment 34, and so of the tilt stay 30 to the window sash 2,4, is required in order to allow the window sashes 2,4 to be tilted without the tilt stay 30 jamming and preventing tilting of the window sashes 2,4. If the tilt stay 30 is simply pivotally attached to the window sashes 2,4 then the tilt stay 30 has a tendency to, in particular when the window sashes 2,4 are fully tilted, to jam prevent the window sashes 2,4 from being tilted back into the vertical position.

The sash attachment 34 is fixed and securely attached to the side frame 16 of the window sashes 2,4 by a pair of fasteners (not shown) for example screws. These fasteners are fixed through fixing holes 56 defined in and towards either end of the sash attachment 34 and into the respective sash frame 16. In an alternative embodiment, shown in FIGS. 7, 8 and 9, the sash attachment 34 includes integral snap-fit fasteners 64,66 to fix and securely attach the sash attachment 34 to the side frame 16 of the window sashes 2,4. These snap-fit fasteners 64,66 fit though and are retained in corresponding locating holes 74 in a wall 72 of the side frame 16 of the window sashes 2,4. As shown a pair of snap-fit fastener arrangements 64,66 are preferably used. Each snap-fit fastener arrangement 64,66 comprises a resilient projection 70 with a distal end of the projection comprising an enlarged snap head 68 defining an end flange or lip at the distal end of the projection 70. The resilient projection 70 and aperture 74 are arranged so that the resilient portion 70 deflects as and to allow the projection 70 and enlarged snap head 68 to be inserted into and through the aperture 74. The enlarged snap head 68 may also have an angled profile to allow for its easier insertion into the aperture 74 and deflection. Once the enlarged snap head 68 has been inserted through the aperture 74 the resilient portion 70 deflects back with the enlarged snap head 68 then overhanging the edge of the aperture 74 and retaining the projection 70 and fastener 64,66 within the aperture 74. This is shown more clearly in FIG. 9.

As shown in this embodiment each snap-fit fastener arrangement 64,66 comprises an arrangement of four individual projections 66a,66b,66c,66d which together cooperatively define a composite cylindrical projection in which each projection 66a,66b,66c,66d comprising a segment of a cylindrical arrangement 66. The respective enlarged snap heads 68 similarly cooperatively define a composite circular head. The projections 66a,66b,66c,66d comprising the segments are spaced from each other such that as the fastener assembly 66 is inserted into a circular aperture 74 the segments 66a,66b,66c,66d can deflect radially inwardly to allow the diameter of the circular head portion 68 to contract and fit through the aperture 74.

It will be appreciated that whilst the snap-fit fasteners 64,66 have been described as being integral with the sash attachment 34 in alternative embodiments the snap-fit fasteners 64,66 could comprise part of the sash frame 16 with the corresponding aperture 74 defined in the sash attachment 34.

To fit the tilt stay assembly 30 into the sash window 1 the window jamb attachment 36 is simply inserted into the respective window jamb channels 22,24, as shown in FIGS. 5 and 6 and described above. With the respective window sash 2,4 in a tilted position, as shown in FIG. 2, the sash attachment 34 is then fixed and attached to the respective side frame 16 of the window sash 2,4 by the fixing screws or by simply snap fitting the snap-fit fasteners 64,66 into fixing apertures 74 in the sash frame 16. Removal of the stay, for example if the window sash 2,4 is to be removed form the window 1 is generally the reverse of the above. In the case of the embodiment using snap-fit fasteners 64,66 these may be difficult to simply remove from their apertures 74 and they may need to be drilled out in order to remove the stay 30 and a replacement stay 30 then fitted.

1. A sash window tilt stay assembly for a tiltable sash window for attachment between a window sash and a window jamb of a sash window, the tilt stay assembly comprising:
an elongate stay member;
a window jamb attachment pivotally attached to a first end of the stay member by a rivet, the window jamb attachment adapted to be slidably engaged within a window jamb channel of the sash window; and
a sash attachment adapted to be attachable and securable to the window sash, the sash attachment including an elongate slot and the stay member including a cooperating spigot which projects from the stay member to attach the sash attachment to a second end of the stay member, the spigot comprising a neck portion and an enlarged distal head portion with the neck portion being slidably and rotatably retained within the elongate slot by the enlarged head portion.

2. A tilt stay assembly as claimed in claim 1 in which the window jamb attachment comprises a central portion and first and second side flanges which oppositely laterally project from the central portion, the window jamb channel including a pair of front walls which partially close off the window jamb channel, and the side flanges being arranged to be slidably engaged within and behind the front walls.

3. A tilt stay assembly as claimed in claim 2 in which the first side flange projects further from the central portion than the second flange.

4. A tilt stay assembly as claimed in claim 2 in which a distal edge of the second side flange has a curved profile.

5. A tilt stay assembly as claimed in claim 2 in which the window jamb attachment is adapted to be fitted into the window jamb channel by inserting the first side flange into the window jamb channel at an angle and subsequently pivoting the window jamb attachment about the first flange to force the second flange over and behind the respective front wall of the window jamb channel.

6. A tilt stay assembly as claimed in claim 1 in which the sash attachment is attached and secured to the window sash by at least one screw fastener.

7. A tilt stay assembly as claimed in claim 1 in which the sash attachment is attached and secured to the window sash by a snap-fit fastener which projects from one of the sash attachment and window sash and is engaged within a corresponding aperture in the other of the sash attachment and window sash.

8. A tilt stay assembly as claimed in claim 7 in which the snap-fit fastener comprises at least one resilient projection with a distal end of the projection comprising an enlarged snap head, the resilient projection being arranged to deflect as and to allow the projection and enlarged snap head to be inserted into and through the aperture with the enlarged snap head then retaining the projection and fastener within the aperture.

9. A tilt stay assembly as claimed in claim 8 in which the snap-fit fastener comprises a plurality of projections which together cooperatively define a composite cylindrical snap-fit fastener assembly with a circular enlarged snap head wherein each of the projections comprises a segment of the composite cylindrical snap-fit fastener assembly.

10. A tilt stay assembly as claimed in claim 8 in which the enlarged snap head has a tapered profile.

11. A sash window assembly comprising a window frame including a pair of vertical window jambs each incorporating a window jamb channel, at least one window sash slidably located within the window frame and tiltable from a vertical position within the window frame, and at least one tilt stay according to claim 1 attached between the window sash and a window jamb.

12. A sash window tilt stay assembly for a tiltable sash window for attachment between a window sash and a window jamb of a sash window, the tilt stay assembly comprising:
an elongate stay member;
a window jamb attachment pivotally attached to a first end of the stay member by a rivet and adapted to be slidably engaged within a window jamb channel of the sash window which includes a pair of front walls which partially close off the window jamb channel, the window jamb attachment comprising a central portion and first and second side flanges which oppositely laterally project from the central portion with the first side flange projecting further from the central portion than the second flange, and the side flanges being arranged to be slidably engaged within and behind the front walls; and
a sash attachment adapted to be attached and secured to the window sash, the sash attachment including an elongate slot and the stay member including a cooperating spigot which projects from the stay member to attach the sash attachment to a second end of the stay member, the spigot comprising a neck portion and an enlarged distal head portion with the neck portion being slidably and rotatably retained within the elongate slot by the enlarged head portion.
